(19) United States
(12) Patent Application Publication
(10) Pub. No.: US 2009/0121504 A1
(43) Pub. Date: May 14, 2009

(54) CORRUGATED STORM PANEL CARRIER

(76) Inventors: Edward A. Wolf, Parkland, FL (US); Mark Clark, Loxahatchee, FL (US)

Correspondence Address: MALIN HALEY AND DIMAGGIO, PA, 1936 S ANDREWS AVENUE, FORT LAUDERDALE, FL, 33316, US

(21) Appl. No.: 11/937,636

(22) Filed: Nov. 9, 2007

(51) Int. Cl. B65G 7/12; B66F 19/00

(52) U.S. Cl. 294/15; 294/164

(57) ABSTRACT

The present invention is a lightweight carrier related to manually lifting and transporting corrugated panels, such as hurricane storm panels, by a single individual. The storm panels are carried manually from a storage area to the location of the house where a user typically installs them, such as a window or door entry into the structure. The carrier further allows the person to carry them up a ladder and to safely place them on an angled roof as the apparatus is designed in such a way as to provide better friction than that of the panels for safe placement during installation and removal of the panels. The hurricane storm panel manual carrier allows an individual to lift and carry one or more small or large hurricane storm panels with ease.

### BACKGROUND OF THE INVENTION

1. Field of the Invention

The present invention relates to a handheld apparatus used to manually lift and carry a plurality of corrugated shaped hurricane storm panels from a first location to a second location.

2. Description of Related Art

Various kinds of tools have been developed that aid in manually lifting and carrying panels. None of the tools assist in manually lifting hurricane storm panels.

U.S. Pat. No. 7,021,606 to Raycraft issued Apr. 4, 2006 discloses an apparatus for lifting sheet rock into place for nailing. However, similarly, the vertical panel lift can not be used for carrying corrugated storm panels to different locations such as from the storage area to a backyard, front yard or garage.

U.S. Pat. No. 5,460,469 to Young issued Oct. 24, 1995 discloses an apparatus comprised of a “U” shaped channel frame with rollers for lifting and moving panels. However, similarly, the typical lifting device is not a simple lightweight lifting and carrying device for corrugated storm panels.

U.S. Pat. No. 5,303,899 to Payla discloses an apparatus for lifting construction elements. A winch is used for elevation. However, similarly, the typical lifting device is not a simple lightweight lifting and carrying device for corrugated storm panels.

### SUMMARY OF THE INVENTION

A handheld carrier for lifting and transporting a plurality of corrugated storm panels comprising a first rigid tubular support, a second rigid tubular support and a third rigid tubular support, said first, second and third tubular supports each connected to specifically configured parallel lifting plates at each end. The end lifting plates are firmly attached to the three tubular supports, one at each end. The first support tube can be used as a manual handle and is disposed near a top edge portion of the end lifting plates at each end.

The end lifting plates have a specific unique configuration with a curved recessed portion commencing on one side and curving inwardly. The size and shape of the end plate recess configuration creates a shaped space for the receipt of a predetermined corrugated panel area for engagement of the corrugated panels. The second and third tubular supports are joined at specific strategic locations on the end lifting plates near the openings of the recessed configurations in the end plates. The second and third support tubes with “O” rings function to engage along with the end plates a specific portion of a corrugated panel on each side firmly engaging the top corrugation on the panel in a manner to firmly hold the panels inside the end plates.

The primary objective of the present invention is to provide a lightweight apparatus for manually lifting and carrying common corrugated storm panels to their destination by at least one individual. It is more particularly directed to carrying the panel or panels from a storage area to the location of the house where one typically installs them, such as a window or door entry into the structure. The apparatus is ergonomic and engages with the side edge of a typical corrugated storm panel. Once the carrier end plates and the panels are engaged, the carrier can be manually raised, allowing the corrugated panels to hang in a controlled fashion, much like a briefcase, for moving or placing the panels at a particular destination.

Another particular object of the invention is to allow a person to carry the storm panels up and down a ladder safely and to place the panels on an angled roof, while preparing to install them or, preparing to bring them back to a storage area. The carrier is further designed in such a way as to provide a high coefficient of friction between the end palate contact surface and a roof surface, using a material with a high coefficient of friction or notches, for safe placement of the carrier during installation and removal of the panels.

Other objects and advantages of the present invention will become apparent from a careful reading of the detailed description provided herein below with appropriate references to the accompanying drawings.

In accordance with these and other objects which will become apparent hereinafter, the instant invention will now be described with particular reference to the accompanying drawings.

### BRIEF DESCRIPTION OF THE DRAWINGS

FIG. 1 is a perspective view of the preferred embodiment of the present invention.

FIG. 2 is a front elevational view of the preferred embodiment of the present invention.

FIG. 3 is a schematic perspective front view of an individual holding a corrugated storm panel, which is in a side view position and fully engaged, using the preferred embodiment of the present invention.

FIG. 4 is a side elevational view of the preferred embodiment of the present invention fully engaged with a corrugated storm panel.

FIGS. 5a through 5g are a series of side elevational view drawings (5a through 5g) showing different orientations of the preferred embodiment of the present invention as the carrier is being engaged to one end of a corrugated panels.

FIG. 6 is a side elevational view of the preferred embodiment of the present invention showing the full engagement of the corrugated storm panel for lifting and transporting.

FIG. 7 is a perspective view of an alternate embodiment of the invention.

FIG. 8 shows a front perspective view of the alternate embodiment of FIG. 7 engaging a series of corrugated panels along one end.

FIG. 9 shows a rear perspective view of the alternative embodiment shown in FIG. 8.

FIGS. 10a-10f show the alternate embodiment of FIGS. 7-9 schematically engaging a series of corrugated panels on one end.

FIG. 11 shows the ultimate embodiment of FIGS. 7-10 schematically being held by a person for transporting corrugated panels using the alternative embodiment.

FIG. 12 shows yet another alternate embodiment of the carrier in a front perspective view engaged with a plurality of corrugated panels.

FIG. 13 shows a rear perspective view of the alternate embodiment shown in FIG. 12.

FIG. 14 shows a front perspective view of the alternate embodiment shown in FIGS. 12 and 13.

### PREFERRED EMBODIMENT OF THE INVENTION

References will now be made in detail to the present preferred embodiment of this invention, one or more examples of which are illustrated in the accompanying drawings. Each example is provided by way of explanation of the invention not limitations of the invention. In fact, it will be apparent to those skilled in the art that modifications and variations can be made in the present invention without departing from the scope or spirit thereof.

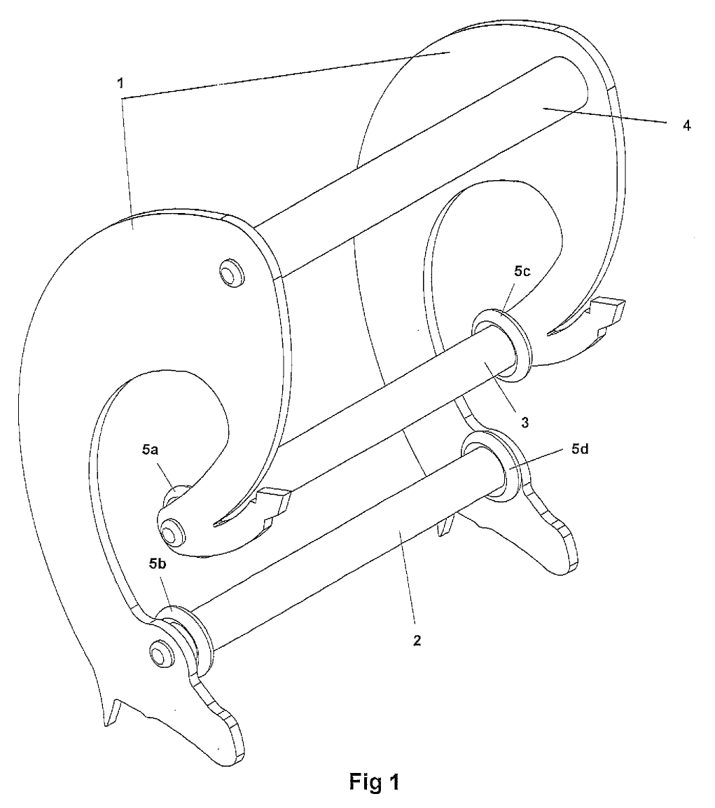

Referring now to the drawing figures and, more particularly to FIG. 1, which shows one embodiment of the present invention comprising of two side end plates 1 attached to each other using a rigid tubular support 2, rigid tubular support 3 and top rigid tubular support 4 (hereinafter called the handle) where “O” rings 5a, 5b, 5c and 5d are installed on each end of bottom tubular support 2 and tubular support 3, providing a surface with a high coefficient of friction to come in contact with the corrugated storm panel surfaces, better securing the panels, once engaged by minimizing the ability for the panels to slip.

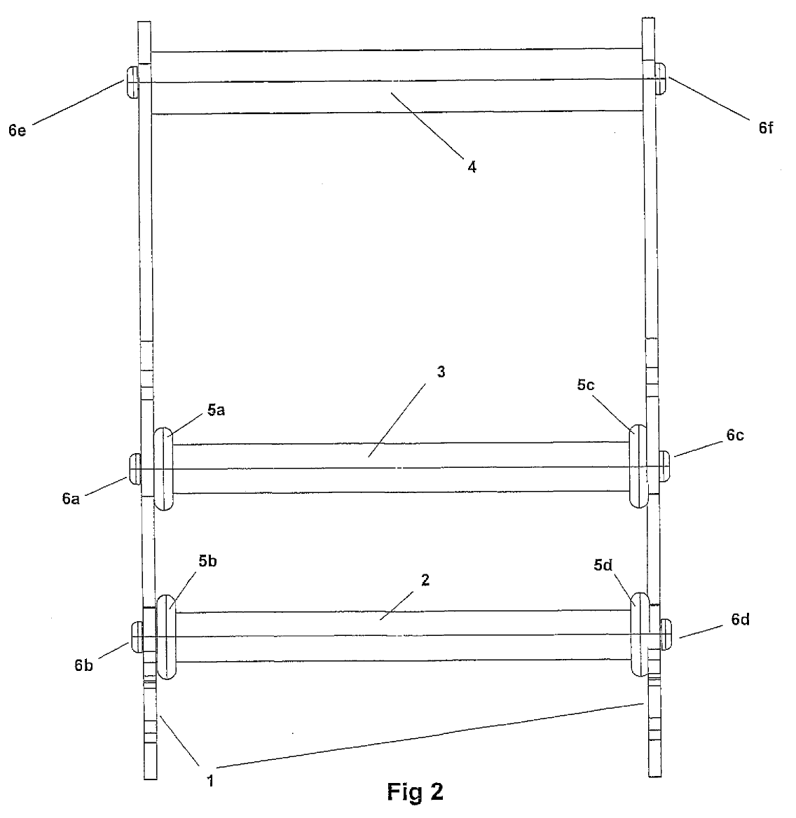

Referring now to FIG. 2, the end plates 1 are attached to bottom rigid tubular support 2, tubular support 3 and the handle 4 using pan head screws 6a, 6b, 6c, 6d, 6e and 6f that protrude through the flat end plates 1 and into each bottom tubular support 2, tubular support 3 and the handle 4.

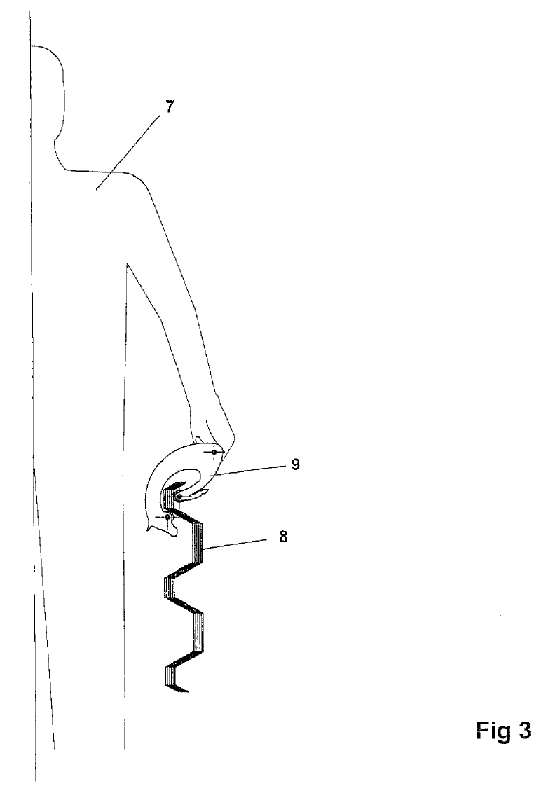

Referring now to FIG. 3, individual 7 manually holds a corrugated storm panel 8 at their side using handle 4 as shown in FIG. 2 wherein the weight of the panel 8 is supported by the preferred embodiment of the present invention 9 in the recessed areas of the end plates 1 and tubular supports 2 and 3 (see FIG. 1). The end plates 1 have curved recessed areas sized and shaped to capture and firmly engage the end portion of corrugated panels 8.

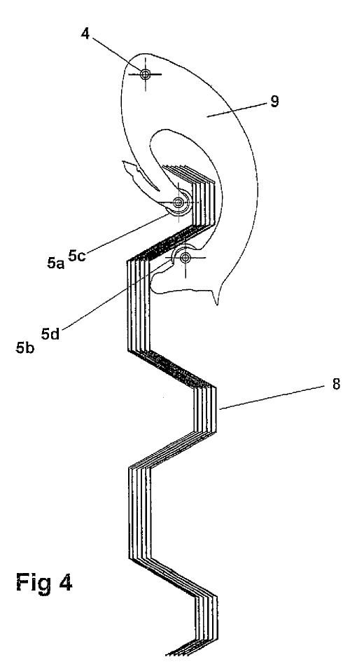

Referring now to FIG. 4, the preferred embodiment of the present invention 9 is shown with the corrugated panel 8 fully engaged wherein the weight of the corrugated panel 8 is supported by each of the “O” rings 5a, 5b, 5c and 5d while the handle 4 is lifted and the corrugated panel 8 hangs from the preferred embodiment of the present invention taking advantage of the corrugated shape of the storm panel and the end plate recess shape.

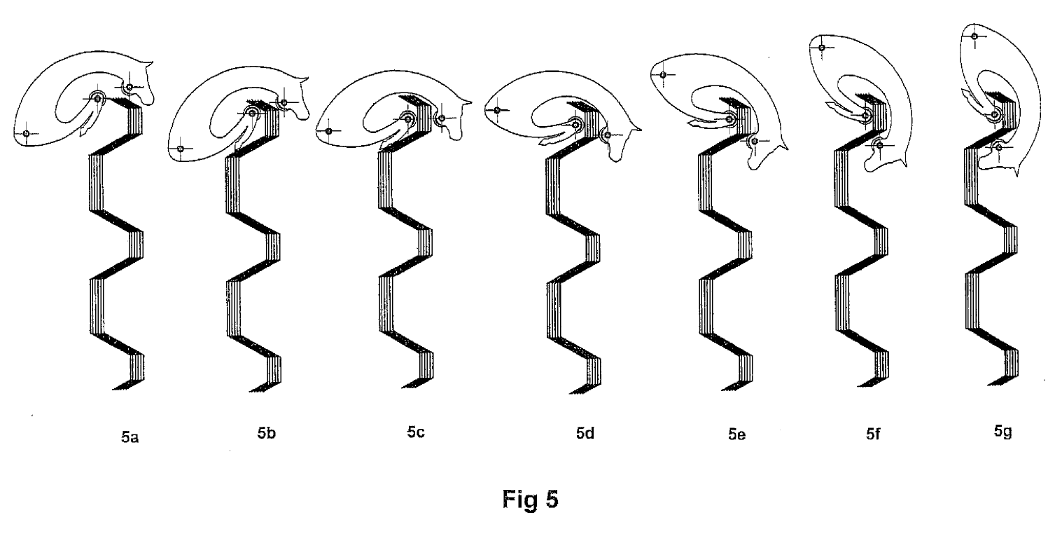

Referring now to FIG. 5, a series of side view drawings (a through g) wherein the series of drawings (5a through 5g) starts with the preferred embodiment of the present invention disengaged 5a and steps through each of the remaining drawings 5b, 5c, 5d, 5e, 5f and 5g until the preferred embodiment of the present invention is fully engaged 5g. The panel sides extend well beyond the carrier end plates 1 in both directions.

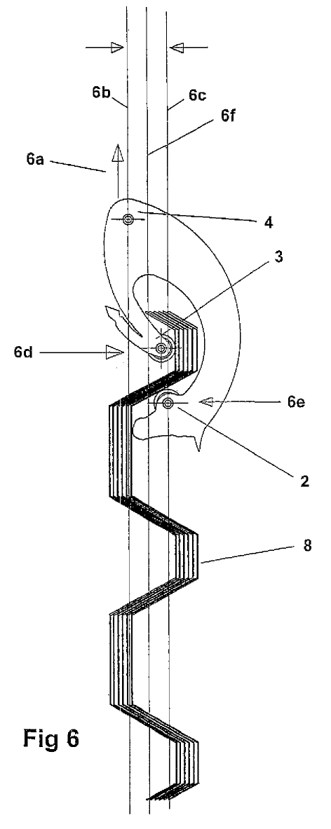

Referring now to FIG. 6, as the handle 4 is lifted vertically upwards, the line of force is vertical 6a with the line of force 6b passing right through the handle 4, the resultant force on bottom tubular support 2 and the associated “O” rings providing all upward vertical force 6c as the bottom tubular support 2 is forced inwards 6e towards the equilibrium centerline 6f while tubular support 3 and the associated “O” rings is also forced inwards 6d towards the panel surface on the other side of the panel as the handle is engaged securing the corrugated panel.

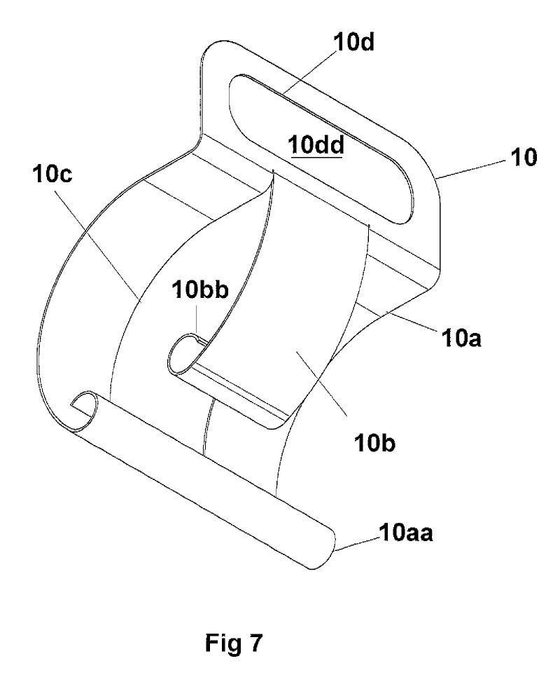

Referring now to FIG. 7, an alternate embodiment of the invention is shown comprised of a single sheet or piece of material such as metal or plastic shown as a corrugated panel carrier 10 that includes a curved, thin body 10a that has a central recess 10c. The carrier 10 also includes a central curled tongue 10b that is curled at its engagement end 10bb. Tongue 10b is curved in the opposite direction than the curved body 10a. The carrier body 10a terminates in a curled or curved cylindrical engaging end 10aa.

The upper segment of carrier 10 includes a handle 10d that has an open space 10dd in which fingers are placed for lifting purposes. By having contoured and curved members on the same carrier body 10 with cylindrical panel engagement ends 10bb and 10aa, a carrier configuration is formed that is sized for receiving the ends of corrugated panels on both sides for engagement and lifting for transporting the corrugated panels together.

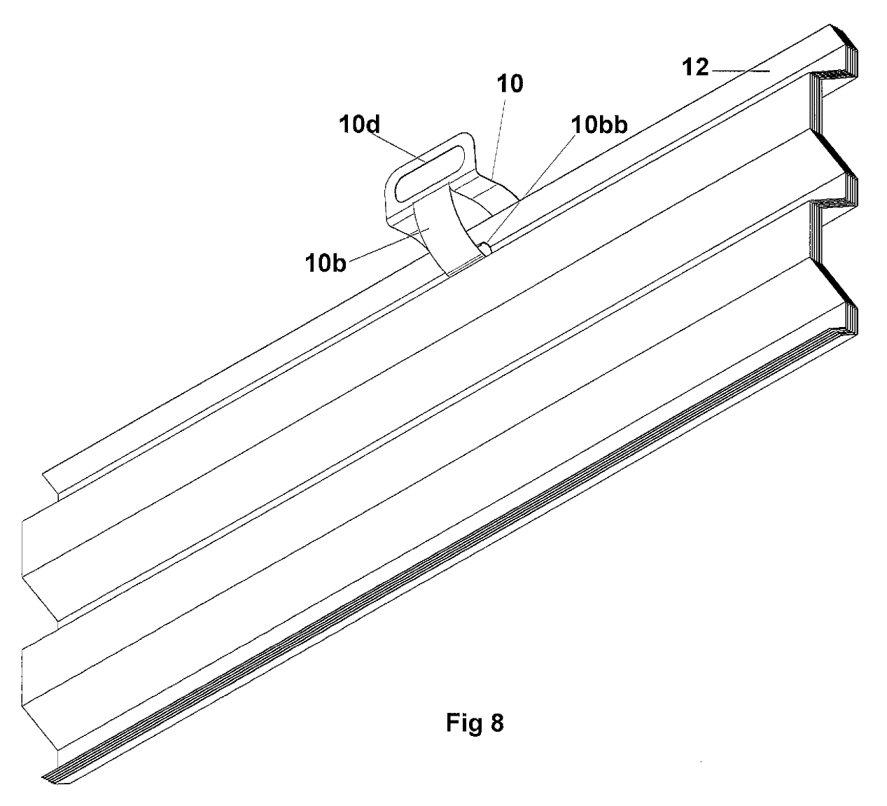

Refer now to FIG. 8 the alternate embodiment of carrier 10 is shown engaged to a plurality of corrugated panels 12 along the top edge of the first panel so that the carrier 10 and its engaging ends such as tongue 10b and base 10bb firmly engage the corrugated panels 12 for manually lifting and transporting.

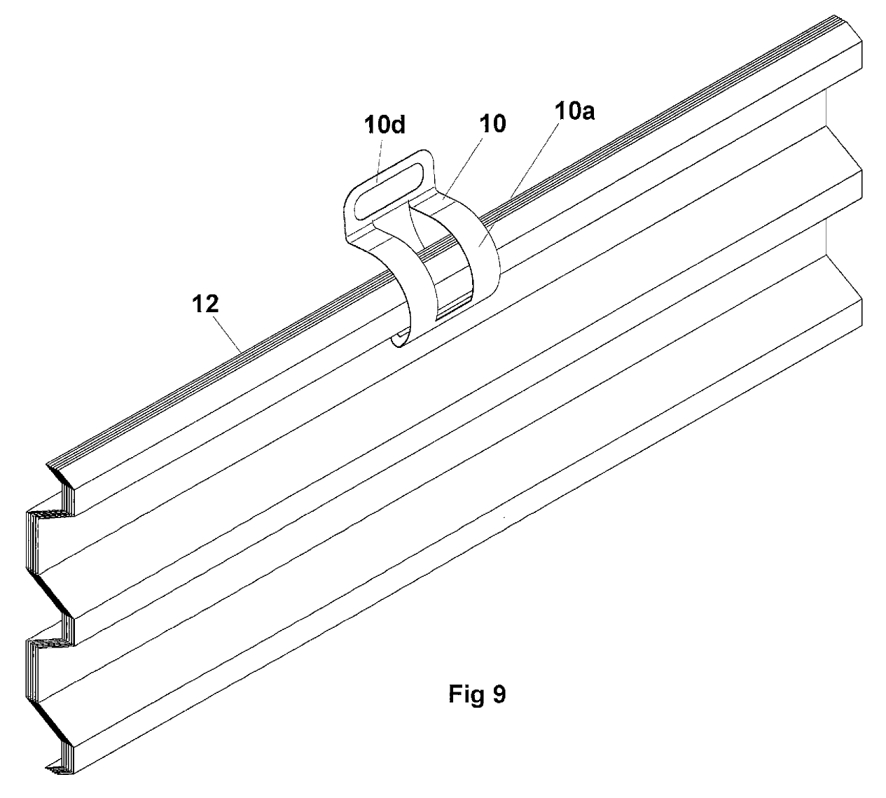

FIG. 9 shows carrier 10 and curved body 10a along with handle 10d firmly engaged with a plurality of corrugated panels 12.

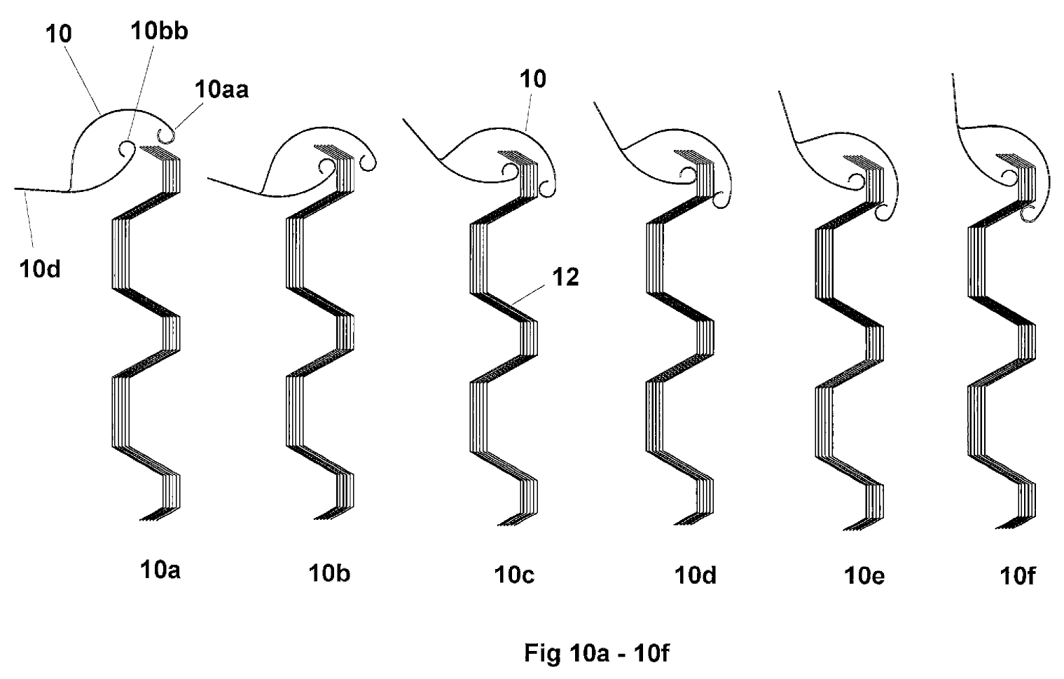

FIGS. 10a through 10f shows series of engagement steps with the carrier 10 as it is positioned with the corrugated panels 12 at each stage by moving and manipulating manually the carrier 10 and the engagement ends 10bb and 10aa until a position is reached that corrugated panels 12 can be lifted directly up using carrier 10 and handle 10d.

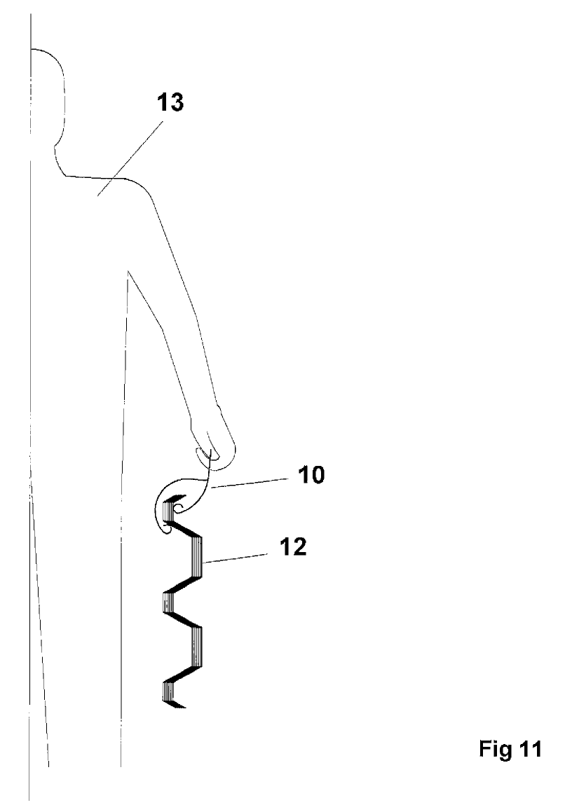

FIG. 11 schematically shows what represents a person 13 transporting corrugated panels 12 using carrier 10.

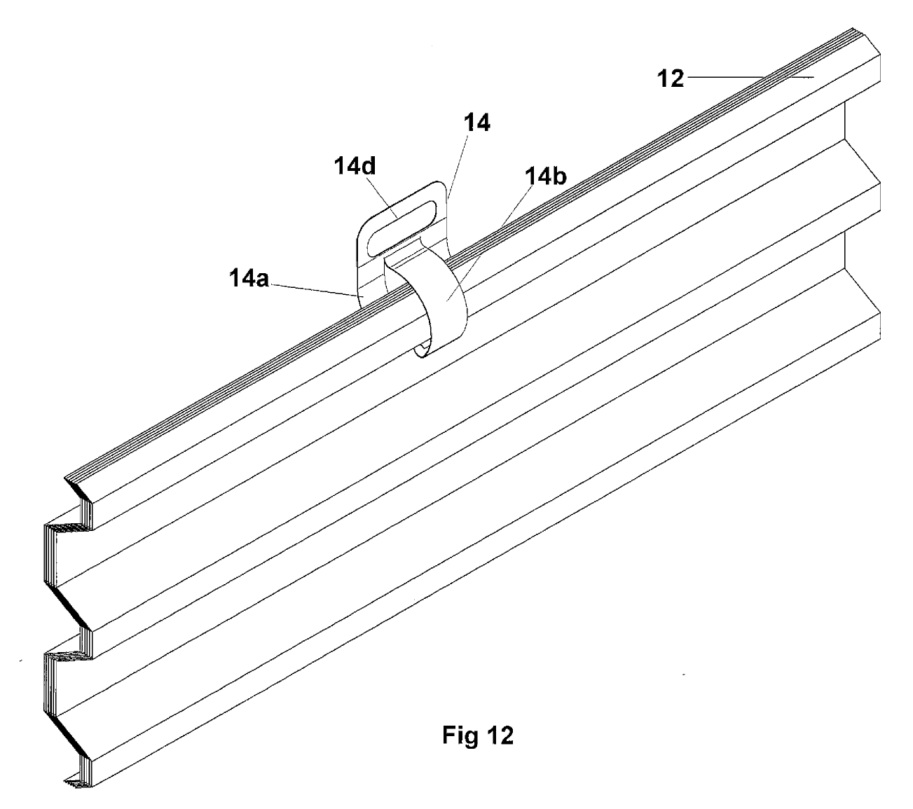

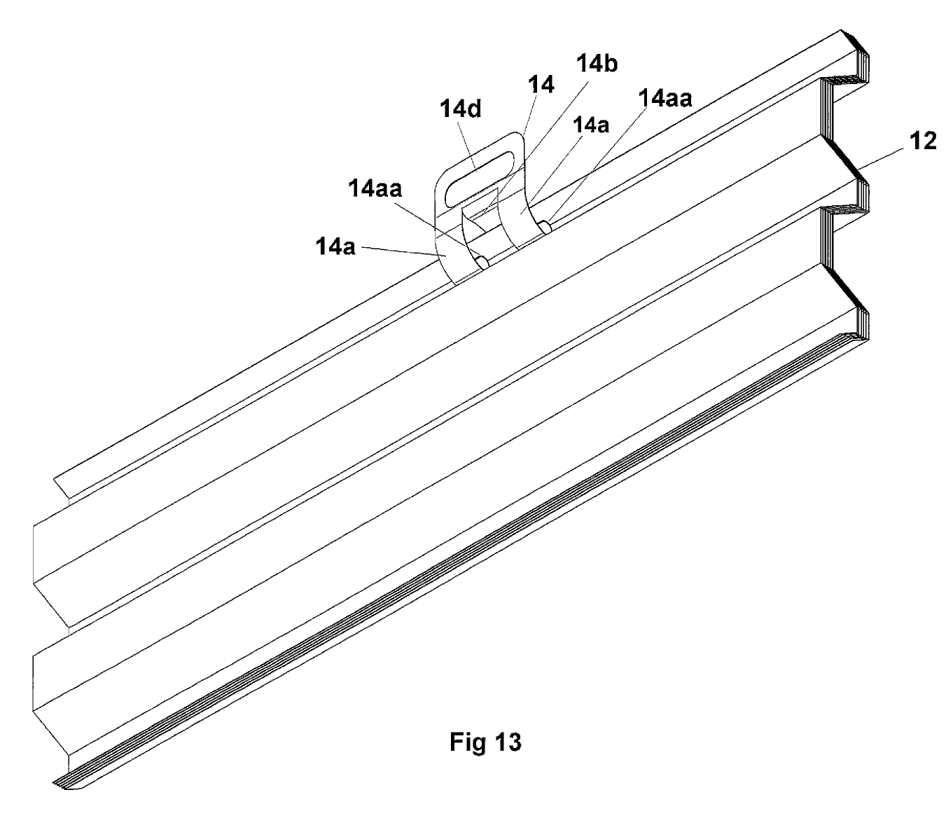

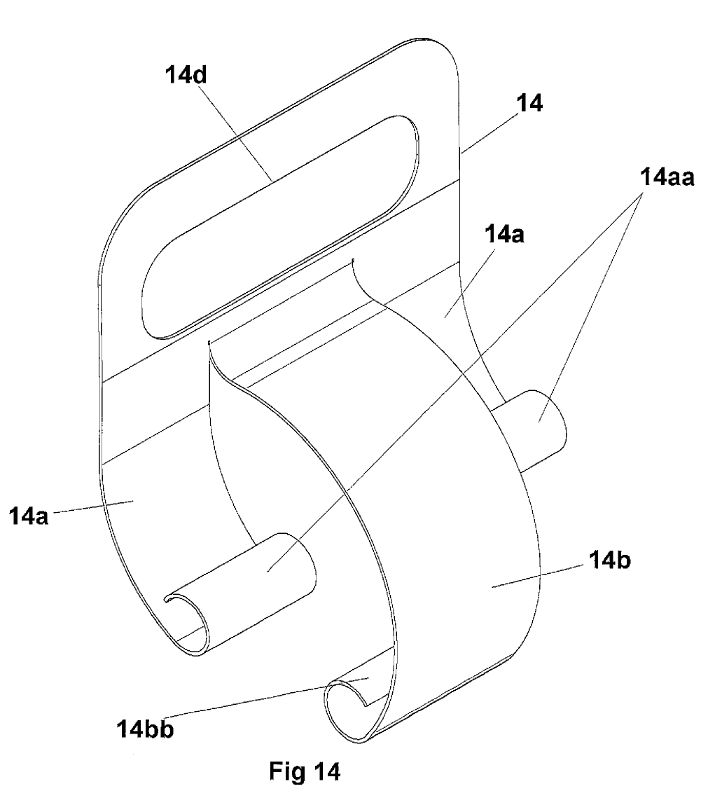

Looking at FIGS. 12-14, yet another alternate embodiment is shown with carrier 14 that includes two curved body portions 14a on one side that are concave and a convex tongue 14b opposing concave portions 14a. The space between the body portions 14a and 14b are sized to receive the ends corrugated panels for firm engagement in a lifting position. Handle 14d is along the carrier top. The carrier 14 is made of a single sheet of material such as metal or plastic. The panel engagement ends 14aa are strategically spaced apart from engagement ends 14bb for proper lifting of the panels. FIG. 13 shows carrier 14 firmly engaged to the end of the plurality of corrugated panels 12 for lifting and transporting.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as herein after claimed.

The instant invention has been shown and described herein in what is considered to be the most practical and preferred embodiment. It is recognized, however, that departures may be made there from within the scope of the invention and that obvious modifications will occur to a person skilled in the art.

What is claimed is:

1. A corrugated panel lifting and carrying device comprising:
a pair of parallel rigid end members;
first and second corrugated panel supports connected between said end members and positioned for engaging a portion of a corrugated panel; and
a handle connecting said end members strategically located for manually lifting which positions the handle relative to the first and second support members for properly engaging a corrugated panel for manually carrying.

2. The corrugated panel carrying device of claim 1, further comprising a material, with a high coefficient of friction, attached to said support feature surfaces, which contact the corrugated panel once fully engaged.

3. The corrugated panel carrying device of claim 1, wherein the material of said support member is rigid.

4. The corrugated panel carrying device of claim 2, further comprising at least one handle attached to two support members, said support members having support features of different lengths, creating an opening for the engagement of a corrugated panel.

5. The corrugated panel carrying device of claim 4, wherein the support members are made from rigid metal or plastic.

6. The corrugated panel carrying device of claim 5, wherein a flexible material is used on the support features to contact the corrugated panel once fully engaged.

7. The corrugated panel carrying device of claim 6, wherein the said flexible material has a high coefficient of friction and limits the amount of slipping by the corrugated shutter, once fully engaged.

8. A corrugated panel lifting and carrying device comprising at least one support member, at least one handle and two support features, said support features of different lengths wherein said support features engage on opposite sides of the corrugated panel, wherein one of the support features engages higher than the other engagement feature when the corrugated panel is standing vertical on the side edge, at least one support feature supporting the weight of said corrugated panel.

9. The corrugated panel carrying device of claim 8, wherein the material of said support member is rigid.

10. The corrugated panel carrying device of claim 1, wherein the rigid support member has notches, wherein said notches create an increased coefficient of friction when in contact with support surfaces.

11. A carrier for lifting and carrying a plurality of corrugated storm panels manually as a unit comprising:
a first flat rigid end plate and a second flat rigid end plate, said first and second end plates each having a substantially similar recessed area of a predetermined curved configuration, said plate recess curve area sized and shaped to firmly engage the first corrugated edge of a corrugated panel end;
a first rigid support connected at one end to said first end plate and at its opposite end to said second end plate, said first and second plates being parallel; and
a second rigid support and a third rigid support each connected at each end to said first and second end plates at strategic predetermined locations adjacent said end plate curved recess configuration area for engaging portion of a corrugated panel end.
